(19) United States
(12) Patent Application Publication
(10) Pub. No.: US 2019/0335971 A1
(43) Pub. Date: Nov. 7, 2019

(54) BACKING PAD FOR USE IN A STAIN REMOVAL PROCESS

(71) Applicant: KONINKLIJKE PHILIPS N.V., Eindhoven (NL)

(72) Inventors: YILE LIAO, EINDHOVEN (NL); SHENGHUAI CALVIN LIN, EINDHOVEN (NL); YONG JIANG, EINDHOVEN (NL)

(21) Appl. No.: 16/093,170

(22) PCT Filed: Oct. 31, 2017
(86) PCT No.: PCT/EP2017/077906

§ 371 Date: Oct. 12, 2018

(30) Foreign Application Priority Data
Nov. 1, 2016 (EP) 16196680.9

(51) Int. Cl. A47L 13/26; A47L 13/16; A47L 25/08; C11D 11/00; C11D 17/04; C11D 3/37; C11D 3/00; C11D 3/50; C11D 3/20; C11D 3/12

(52) U.S. Cl. CPC A47L 13/26; A47L 13/16; A47L 25/08; C11D 11/0017; C11D 17/049; C11D 3/3769; D06F 43/002; C11D 3/3761; C11D 3/3707; C11D 3/0047; C11D 3/50; C11D 3/2086; C11D 3/1233; C11D 3/3753

(57) ABSTRACT

The present invention relates to a backing pad (800) for locally removing stain spots on garments, said backing pad (800) comprises a fluid-absorptive upper layer (801) and a fluid-impermeable lower layer (802), whereby said upper layer (801) and said lower layer (802) are stacked on each other and the upper layer (801) comprises a superabsorbent.

### FIELD OF THE INVENTION

The present invention relates to the field of stain removal, and in particular it relates to a backing pad used for fluid absorption in a stain removal process.

### BACKGROUND OF THE INVENTION

Fabrics, a class of material that is common used for garment and furnishing, can be easily contaminated by contaminants such as food, drinks and writing markers. The contamination typically results in unsightly stain spots that cannot be removed easily without washing the fabric. In some occurrences, the stains may even require extensive local pre-treatment prior to the laundry process. These are troublesome processes that can only take place when the whole fabric is due for washing.

However, the removal of stain spots immediately upon staining is usually preferred. Local removal of stain without the need of washing the whole garment is highly desired. This keeps the fabric looking clean even if the next laundry cycle is not immediate.

There exists some known portable device able to locally remove stain in a quick manner, in particular by applying a chemical agent on the stain area, such as stain dissolving solutions, oxidation chemicals or detergents.

In those known solutions, since the chemical agent is a fluid, there is a need to find a solution to prevent the user wearing the stained garment to get wet around the stain area, and limit the contact of the chemical with user's skin.

### SUMMARY OF THE INVENTION

It is an object of the present invention to provide an improved backing pad that avoids or mitigates above-mentioned problems.

The invention is defined by the independent claims. The dependent claims define advantageous embodiments.

To this end, the backing pad for use in a stain removal process according to the invention comprises:
an upper layer being fluid-absorptive,
a lower layer being fluid-impermeable,

The upper layer and the lower layer are stacked on each other. The upper layer comprises a superabsorbent.

The present invention is based on the principle to improve stain removal processes using water or other fluids, by an increased fluid absorption in the backing pad.

In general, this invention is applicable to any processes involving fluid absorption and retaining, preventing fluid overflow and contamination with other objects.

In stain removal processes on the run, stains have to be removed quickly, without any residues and the treated clothes have to be ready for use immediately after stain removal. In particular, this implies that the treated clothes have to be dry after the stain removal process.

With a backing pad used to absorb the wet from cleaning, drying time can be shortened significantly. Furthermore, the fluid-impermeable lower layer prevents contamination of other materials with the absorbed fluid. Operation desks and other fabric parts of the treated clothes remain clean and dry.

Preferably, the superabsorbent is comprises a hydrophilic polymer.

Preferably, the superabsorbent is chosen from a copolymer or a polymer including at least one of a acrylonitrile based copolymer, an acrylamide based copolymer and a polyvinyl alcohol (PVA) based copolymer, poly acrylic acid, poly(vinyl alcohol), poly ethylene oxide (PEO). These substances provide for better water retaining and prevent fluid overflow in stain removal processes.

Preferably, the upper layer comprises any one of the following structure:

a) a single layer comprising a mixture of fluid-permeable fibrous material and superabsorbent polymer being stacked on the lower layer,
b) a first layer comprising fluid-permeable fibrous material arranged adjacent to a second layer comprising a mixture of fluid-permeable fibrous material and superabsorbent polymer,
c) a first layer comprising fluid-permeable fibrous material being stacked on the lower layer, a second layer comprising a mixture of fluid-permeable fibrous material and superabsorbent polymer being stacked on the first layer, and a third layer comprising fluid-permeable fibrous material being stacked on the second layer.

Preferably, the lower layer is made of a material comprising any one of plastic sheets, metal sheets, rubber sheets, wax paper, leather sheets and glass sheets. All these materials prevent letting out the absorbed fluid on the lower side of the backing pad. This prevents contamination of working surfaces with the absorbed fluid.

Preferably, the upper layer of the backing pad comprises a pH indicator configured to indicate acidity or alkalinity of fluid getting in contact with the upper layer.

Preferably, the pH indicator is configured to indicate acidity or alkalinity by color via a change of color when the fluid getting in contact with the upper layer is acidic or basic. For example, said pH indicator may exhibit color change as a function of pH value change. If the chemical cleaning agent used is acidic or alkaline, when it touches the backing pad, the color of the pad will change gradually as an indication of the presence of a cleaning agent. Hence, the color change is indicative for the start of the stain treatment and gives the user feedback that the stain is under removing reaction.

Preferably, the backing pad comprises at least two compartments that are isolated from each other by an impermeable barrier.

Thereby, cross-contamination between the different compartments is prevented.

Preferably, the upper layer may comprise fragrance and/or perfume agents.

These additives create a better user perception during the stain removal process.

In an embodiment of the backing pad, each of said at least two compartments comprises a different fragrance and/or perfume agent.

Different scents may also be used in different areas of the pad.
Preferably, the upper layer comprises a chemical neutralizer.
Preferably, the chemical neutralizer is selected among any one of the following:
weak acid-like citric acid and/or sodium citrate,
weak alkaline-like sodium carbonate and/or sodium bicarbonate,
reducing agents.
   Since most cleaning agents are alkaline bases, weak acid like citric acid and sodium citrate are good choices to neutralize pH.
   Preferably, the backing pad is foldable.
   This feature contributes to save space.

Preferably, the backing pad further comprises an additional layer cooperating with any one of the upper layer and the lower layer.

The additional layer provides mechanical stability and/or protection to the backing pad.

Preferably, the upper layer and/or the lower layer are made of a heat resistant material. Having a backing pad heat resistant is particularly important when irons, hair dryers or the heat from a stain removal device are used to accelerate the drying process. Otherwise the backing pad may change chemically or even start burning. This may contaminate the treated fabric with new stains or odors or even destroy said fabric.

### BRIEF DESCRIPTION OF THE DRAWINGS

These and other aspects of the invention will be apparent from and elucidated with reference to the embodiment(s) described hereinafter. In the following drawings

FIG. 1 is a simplified module diagram of a portable device for removing the stains on the fabrics according to an embodiment of the present invention;

FIG. 2 is another simplified module diagram of a portable device for removing the stains on the fabrics according to an embodiment of the present invention;

FIG. 3, FIG. 4 and FIG. 5 are respectively a perspective view, a front view and a side view of a portable device for removing the stains on the fabrics according to an embodiment of the present invention;

FIG. 6 and FIG. 7 are respectively a front view and a side view of a portable device for removing the stains on the fabrics according to an embodiment of the present invention;

FIG. 8, FIG. 9 and FIG. 10 are respectively a back view, a side view and a top view of a portable device for removing the stains on the fabrics according to an embodiment of the present invention;

FIG. 11 is another simplified module diagram of a portable device for removing the stains on the fabrics according to an embodiment of the present invention;

FIG. 12A to FIG. 12D is a set of schematic usage flow charts of the portable device for removing the stains on the fabrics according to an embodiment of the present invention;

FIG. 13 are various schematic perspective views of a portable device using guide head for removing the stains on the fabrics according to an embodiment of the present invention;

FIG. 14 shows the chemical formation of H₂O₂ from sodium percarbonate,

FIG. 15 shows the chemical formation of peroxy acid from TAED,

FIG. 16 shows the chemical formation of peroxy acid from DOBA,

FIG. 17A is a schematic side view of the stain removal device as well as the chemical reagent bag and the holder of a portable device using holder for removing the stains on the fabrics according to an embodiment of the present invention;

FIG. 17B are internal schematic side view of the stain removal device as well as the chemical reagent bag and the guide head of a portable device using guide head for removing the stains on the fabrics according to an embodiment of the present invention;

FIG. 18A to FIG. 18F is a set of schematic usage flow charts of the portable device with guide head and chemical reagent bag for removing the stains on the fabrics according to an embodiment of the present invention;

FIG. 19 is a schematic front view of a selectable pathway piece of the device according to an embodiment of the present invention;

FIG. 20 and FIG. 21 are two application situations for the selectable pathway piece of the device according to an embodiment of the present invention;

FIG. 22, FIG. 23 and FIG. 24 are other three application situations for the selectable pathway piece of the device according to an embodiment of the present invention;

FIG. 25A to FIG. 25C are schematic exploded views of backing pads according to the present invention comprising an additional layer;

FIG. 26 is a schematic front view of a backing pad according to the present invention comprising at least two compartments;

FIG. 27A to FIG. 27D is a set of schematic views of a backing pad according to the present invention;

FIG. 28A to FIG. 28C is a set of schematic front view of a backing pad according to the present invention embedded with one or more additives;

FIG. 31 is a configuration diagram showing the power supply applied to heat up the chemical mixing tank and the heated plate, while pump 1, pump 2 and brush are mechanical according to an embodiment of the present invention;

FIG. 32 is a configuration diagram showing the power supply applied to heat up the chemical mixing tank and provided electricity to the chemical dispensing pump and rotary brush according to an embodiment of the present invention;

FIG. 33 is a configuration diagram showing the detachable power supply similar as cordless iron applied to heat up the chemical mixing tank and the heated plate, while pump 1, pump 2 and brush are mechanical according to an embodiment of the present invention;

FIG. 34 is a configuration diagram showing a steam generating stain remover device with a detachable power supply according to an embodiment of the present invention.

FIG. 35 shows a backing pad used in a stain removal process with a stain removal device,

FIG. 36A to FIG. 36C illustrate different embodiments of a backing pad according to the present invention implementing different fluid-absorptive upper layers.

### DETAILED DESCRIPTION OF THE EMBODIMENTS

The backing pad according to the invention is especially suitable to be used together with a hand-held stain removal device which is able treat stain spots on garments locally without the need of washing the whole garment. Said hand-held stain remover device may have any combination of integrated functions of the following stages:
1) stain treatment by water/steam or by chemical cleaning, or by water/steam plus chemical cleaning;
2) rinsing off stain residues and chemical residues;
3) evaporating water from the treated area of the garment.

At stage 1, the process involves various chemicals and chemical solutions (around 3 to 5 mL of chemical cleaning solution to be used to remove a stain in 5 cm diameter), and the absorption pad (also called backing pad) is put underneath the stained garment to prevent chemical contamination of operation tables and desks. In order to avoid the solution used to expand, the upper (i.e. top) layer of the pad should is fluid-absorptive and fluid-permeable. Materials can be hydrophilic polymer, cotton, synthetic fiber or any combination of these. The porous structure of the pad helps absorb the rinsing fluid and the micro fibers are formed as capillaries to guide said fluid through. Superabsorbent is added to the pad to further enhance the fluid retaining capacity. On the other hand, the bottom layer of the absorption pad is non-permeable to water and chemical solutions may comprise polyester, polyethylene, or wax paper.

At stage 2, water will be dosed on the stained treatment area to rinse off the stain residues and cleaning agents/chemicals. 10-100 mL water should be used depending on the residue amount, which means that the absorption capacity of the backing pad per unit of area needs to be sufficient to avoid flooding.

At stage 3, rinsing water left on the garment from stage 2 will be evaporated by heating to 100-200° C. depending on the stain, the chemical(s) used and the garment type to be treated. Taking the high temperature into consideration, the pad material for a drying stage should be heat resistant. Cellulose fibers like cotton fiber and wood pulp fluff are preferred materials.

The backing pad according to the invention is meant to put underneath the stained garment to achieve better results and user experience for each of the above stages 1) 2) 3).

Note that the backing pad according to the invention may also be used in stain removal processes without said stain removal device. For example, the backing pad may be used during treating a stained garment chemically with other appliances. The pad may also be used during rinsing using a conventional spray bottle. Put behind the garment the backing pad may then absorb excess fluid. Besides, drying wet garments using conventional irons or hair dryers, for instance, may be accelerated by the highly absorptive backing pad.

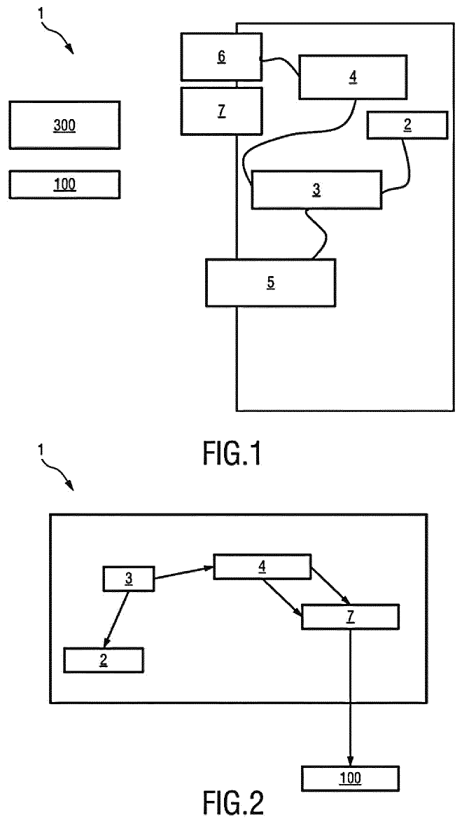

FIG. 1 and FIG. 2 show two simplified schematic diagrams of a portable stain removal device 1 for removing a stain on a fabric 100 according to an embodiment of the present invention. Actually they are substantially similar or same.

The fluid (also called liquid) 200 for the rinsing process can be water, an aqueous solution, a neutralizer, a vapor or a powder. But in this embodiment, the fluid 200 for rinsing is water (steam and liquid water). In this embodiment, the liquid 200 is stored in the liquid tank 2. A dispensing mechanism 3, for example a pump, is attached to the liquid tank 2 for transferring the water 200 out of the liquid tank 2 to a steam engine 4 which is configured to convert the liquid water 200 into steam 200. The dispensing mechanism 3 is activated by operating a rinsing pump trigger 5. The steam 200 provided by the steam engine 4 is released from the stain removal device 1 by means of an outlet 6. The optional drying method is heating with a heated plate 7. The steam venting face of the stain removal device 1 is then directed to the stained fabric 100 or a cleaning reagent 300 on the fabric 100. The cleaning reagent 300 may also be called chemical reagent, chemical, cleaning agent or stain removing material in the following.

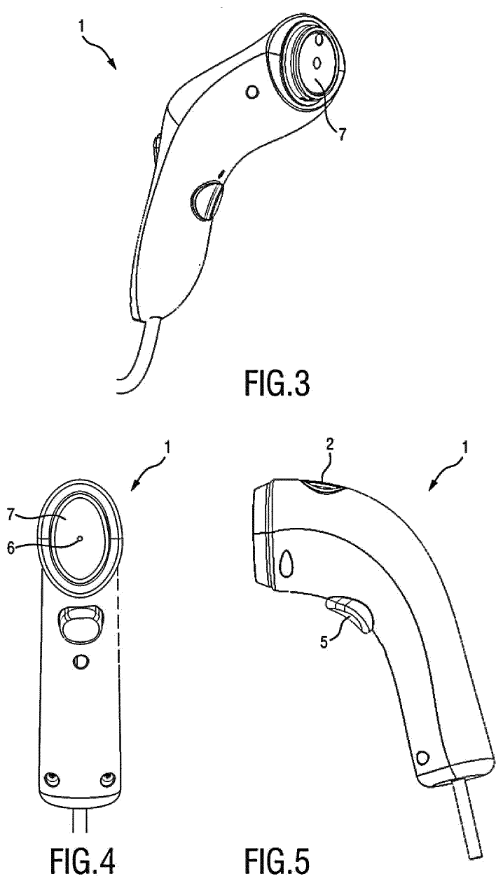

FIG. 3 to FIG. 5 are respectively a perspective view, a front view and a side view of a portable device 1 for removing a stain on a fabric 100 according to an embodiment of the present invention. A liquid tank 2 supplies water 200 to a dispensing mechanism 3, for example a pump. The pump 3 supplies water 200 to a steam engine 4. The steam engine 4 supplies steam 200 to the fabric 100 through an outlet 6, i.e. an opening which may be represented by a nozzle, on a heated plate 7. In the optional subsequent drying process, the plate 7 is also heated by the steam engine 4.

The opening 6 on the heated plate 7 is sized to enable the outgoing steam 200 to have a certain velocity. This velocity is a function of the size of the opening and the steam rate. For a steam rate of 25 g/min, the optimal opening dimension is 6 mm in diameter. This combination gives a good steam rate and velocity to enhance the rinsing because the velocity creates a pressure difference between the treatment side and underside of the fabric 100. The pressure difference pushes the fluid 200 through the fabric 100. The relatively low steam rate also enables longer operation without the need for a large liquid tank 2.

Optionally, the steam rate can be between 5 g/min and 150 g/min. The diameter of the opening 6 can be between 3 mm and 30 mm. The steam 200 can be pure dry steam 200 (commonly transparent and hard to be envisaged by naked eyes) or wet steam 200 (commonly white color). It was observed that wet steam 200 (steam with droplets of water) produced better rinsing results but wetter fabric 100.

Rinsing duration is dependent on the required quality of rinse. It was observed that rinsing duration should be at least 10 seconds with this defined opening size and steam rate. The rinse duration should be at least 3 seconds for such a device 1 of the present invention.

Optionally, after the rinsing process, the heated plate 7 may also be used for drying. During drying, the heated plate 7 should have a temperature between 60° C. and 170° C.

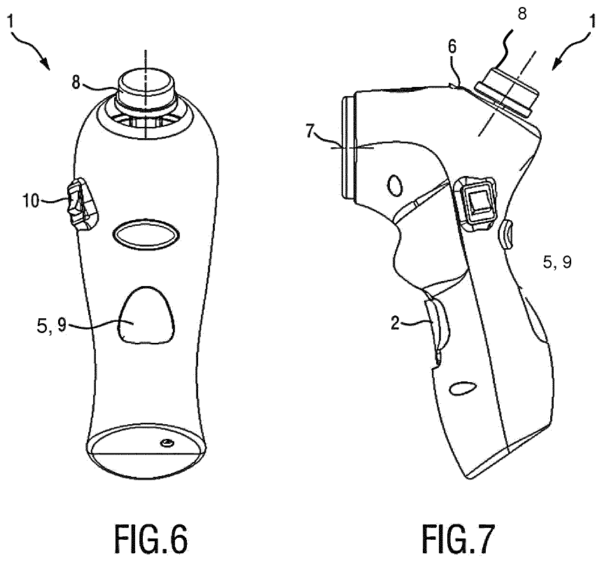

FIG. 6 and FIG. 7 are respectively a front view and a side view of a portable device 1 for removing a stain on a fabric 100 according to an embodiment of the present invention. This embodiment consists of a heated plate 7, a liquid tank 2 for holding rinsing water, a dispensing mechanism 3, i.e. a rinsing pump 3, to supply water 200, a rinsing pump trigger 5, a brush 8 (optionally an electro-mechanical motor brush) and an optional temperature switch 10.

The water tank 2 supplies water 200 for rinsing to the rinsing pump 3. The rinsing pump 3 supplies water 200 to an outlet 6 (rinse fluid outlet) beside the brush 8. During rinsing, fluid 200 is pumped out of the outlet 6 and onto the fabric 100 for the purpose of dilution or neutralization the residual chemical reagent. The brush 3 provides a mechanical means and a pressure means of helping the rinse fluid 200 pass through the fabric 100 and/or out of the fabric 100. The rinsing fluid dosing rate can be between 5 g/min and 150 g/min. The brush 8 can be mechanical operated or powered by an electric motor to have a speed between 10 and 500 revolutions per minute. The brush 8 is activated by operating the brush trigger 9. The rinse fluid 200 may also be a chemical neutralizer.

When rinsing is completed, the user may select to move on to the optional drying. The heated plate 7 is placed onto the rinsed fabric 100 to provide for localized drying, similar to the action of an electric iron. The process is completed upon drying of the fabric 100.

The temperature switch 10 on the device enables two temperature settings. This is optional but could be beneficial for treating different fabric types. For instance, delicate fabrics 100 require lower temperature for drying, while normal fabrics 100 can withstand higher temperatures for faster drying.

Alternatively, drying may be achieved through other means of providing heat or air movement, such as hot air, radiation, moving air or vacuum extraction.

So for these two above-mentioned embodiments, they describe a portable device 1 for removing a stain on a fabric 100. It has the characteristics and/or technical benefits as follows:

1. The portable device 1 is capable of rinsing and drying a targeted area of a fabric 100, where rinsing is done through the application of a fluid 200. The fluid 200 can be an aqueous solution, a neutralizer, a vapor or a powder. Drying is conducted by applying one or more of heat, fluid motion and absorbent material.

2. The transmission of the fluid 200 from one side of the fabric 100 to the other side during the rinsing may be aided by a device or means of applying pressure or force onto the fluid 200 or fabric 100, such as a pump 3, a brush 8 or velocity of a fluid 200.

3. In this device 1, heat in the drying process can be provided through direct contact of the target fabric 100 with a heated plate 7. Optionally, the heat may also be provided through radiation or hot air.

4. In this device 1, the rinsing process can be conducted through the addition of water 200 to dilute the chemical 300, followed by a brush 8 which removes excess water. Heated water 200 has better rinsing results. Optionally, the neutralization/dilution may be achieved by using a chemical neutralizer or another dilution medium. The process of post-dilution water extraction is optional, but it greatly enhances the rinsing effect. The post-dilution water extraction may also be achieved through other mechanical means, such as a tapping motion, rubbing motion, high velocity steam 200 and so on.

5. In this device 1, drying is achieved through heating of the post-rinse area with the heated plate 7 at elevated temperature in the range of 60-170° C. Optionally, hot air of over 60° C. may also be used for drying.

In conclusion, the above described invention is a portable fabric treatment device 1. The device 1 has the function of rinsing and drying a portion of a fabric 100. The ability to only rinse and dry a targeted portion of a piece of fabric 100 enables this device 1 to do localized fabric treatment. For the rinsing process, this device 1 uses a fluid 200 for dilution and a pressure difference to extract waste and excess fluid 200. The device 1 also uses heat to further dry the fabric 100 after the rinsing process. The integration of these functions enables the user to use the fabric 100 immediately after the proposed optional one/two step(s) of fabric treatment. The main advantage is that the fabric 100 can continue to be in service prior to the next laundry cycle.

As for the implementation of integrating all the three potential processes in a stain removing device 1, please see the content as follows.

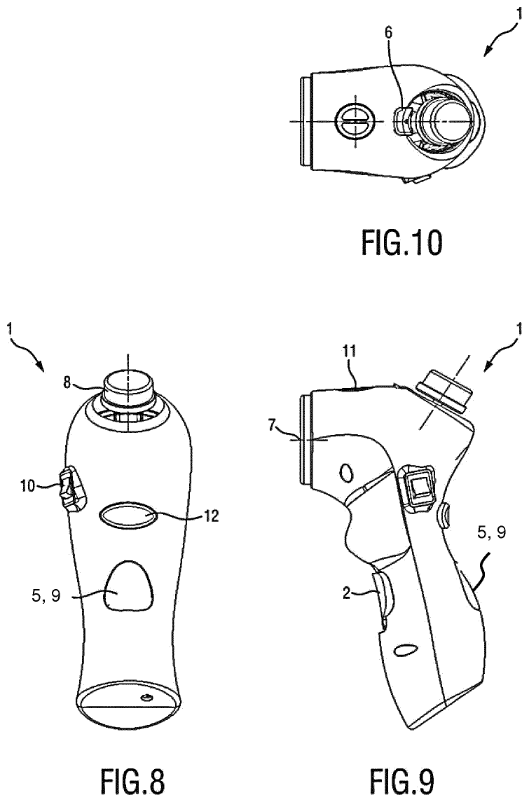

FIG. 8, FIG. 9 and FIG. 10 are respectively a back (or front) view, a side view and a top view of a portable device 1 for removing a stain on a fabric according to an embodiment of the present invention.

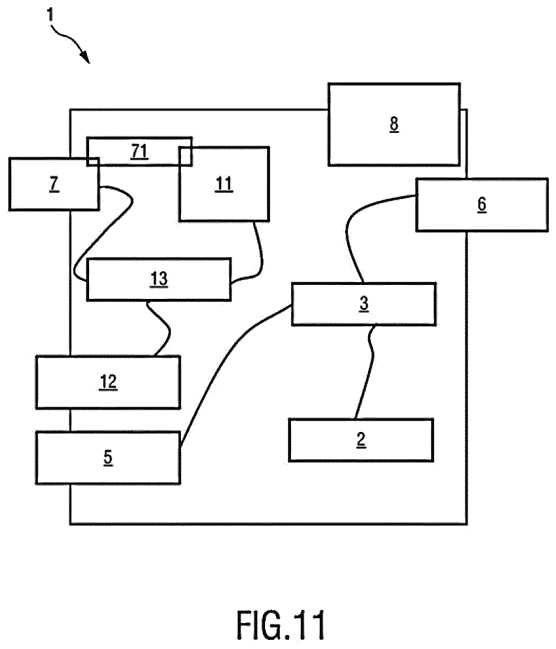

FIG. 11 is another simplified module diagram of a portable device 1 for removing the stains on a fabric 100 according to an embodiment of the present invention.

This embodiment can consist of a heater 71, a heated plate 7, a chemical mixing tank 11, a chemical dosing trigger 12, a chemical dosing pump 13 and the required hose lines, a water tank 2 for holding rinsing water 200, a rinsing pump 3 to supply water 200, a rinsing pump trigger 5, a brush 8 (optionally electro-mechanical motor brush) and a temperature switch 10.

The usage of this device 1 can be classified into the three main processes: stain removal, rinsing and drying. These processes can occur as the listed order.

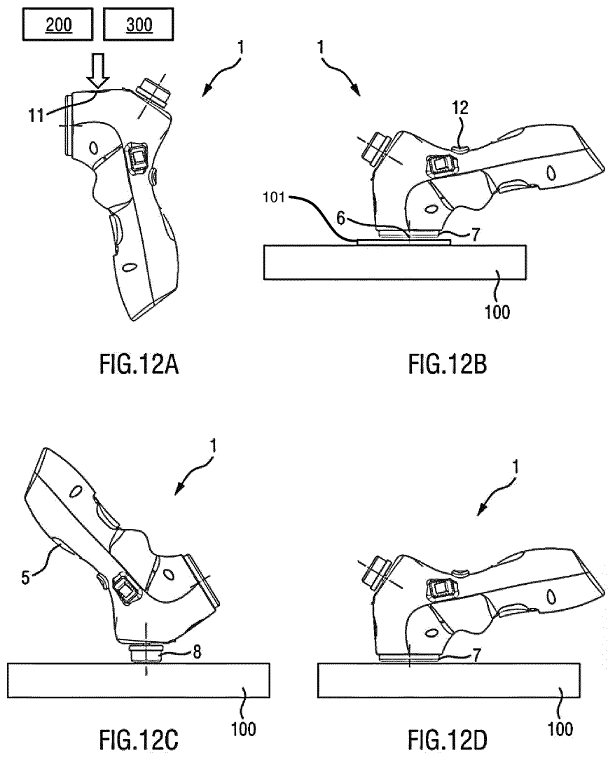

FIG. 12A to FIG. 12D is a schematic usage flow chart of the portable device 1 for removing a stain on a fabric 100 according to an embodiment of the present invention.

FIG. 12A shows the beginning of the stain removal process, wherein the chemical mixing tank 11 of the device 1 is preferably first heated, such that the chemical mixing tank 11 reaches a temperature of at least 65° C. The optimal temperature is between 80-90° C., though a temperature range of 65° C. to 120° C. is acceptable. Chemical 300 and water 200 are then added to the mixing tank 11 for dissolving the chemical 300 to form an aqueous solution. This chemical mixing tank 11 should be vented to prevent excessive gas build-up during the chemical solution preparation. Alternatively, this chemical solution can be prepared outside of the device 1 and added to the device as an aqueous solution.

FIG. 12B shows the chemical treatment phase of the stain removal process. When the chemical 300 has dissolved, it is dosed onto the stained fabric 100 by activating the chemical dosing trigger 12. The chemical dosing trigger 12 activates the chemical dosing pump 13 to dispense the chemical 300 through an outlet 6 on the heated plate 7. As the hot chemical 300 is being dispensed, the heated plate 7 should be placed on the surface of the stained fabric 100 to enable heating of the wetted fabric 100. The heat provided during the stain removing process is optional, but can greatly enhance stain removal result and speed by accelerating the chemical reaction. Alternatively, heat can be applied through other forms of heating, such as hot air, steam, microwave and exothermic reaction.

FIG. 12C shows the rinsing phase of the stain removal process. Once the stain visibility has been reduced to a level that is acceptable by the user, the device 1 will enter the second phase of stain removal: rinsing. In the rinsing phase, the brush head 8 of the device 1 is placed on the fabric 100 that is to be rinsed. The rinsing pump trigger 5 is then activated to activate the rinsing pump 3. Water 200 is pumped from the rinsing water tank 2, i.e. the liquid tank 2, through the pump 3 and out from an outlet 5 beside the brush 8. This process dilutes the chemical residue and washes the fabric 100 using water or aqueous solution. At the same time, the motorised brush head 8 is activated to provide mechanical scrubbing action to push the waste water through and out of the fabric 100. Alternatively, the motorised brush 8 may be replaced by a sub-device that is able to provide mechanical action, such as a tapping motion, a forward-backward linear motion or a circular motion. Alternatively, a chemical neutraliser 200 may be applied to neutralise the residual chemical.

FIG. 12D shows the drying phase of the stain removal process. When rinsing is completed, the user moves on to the third process, which is the drying process. This process is optional and does not affect the stain removal process. However, it brings extra convenience to the user, such that the treated fabric 100 can be used almost immediately without waiting for the fabric 100 to dry. The temperature switch 10 of the device 1 is first activated to raise the temperature of the heated plate 7 to approximately 150° C. Alternatively, a temperature range of 100° C. to 170° C. is suitable for drying. The heated plate 7, which will be used for drying, should be cleaned prior to the drying process. The heated plate 7 is placed onto the rinsed fabric 100 to provide for localised drying, similar to the action of an electric iron. The process is completed upon drying of the fabric 100. Alternatively, drying may be achieved through other means of providing heat or air movement, such as hot air, radiation, moving air or vacuum extraction.

So for this above-mentioned embodiment, it describes a portable device 1 for removing the stains on the fabrics. It has the characteristics and/or technical benefits as follows:

1. The device 1 uses a chemical method for stain removal, where the chemical reaction is accelerated with heat to enhance stain removal speed and result. The device 1 also has a method of rinsing, which is the extraction or dilution of the chemical 300 to prevent further undesired chemical reaction, prior to the next wash cycle. This device 1 may also include an optional drying mode to dry the local post-rinse wet spot.

2. In this device 1, heat is provided through direct contact of the target fabric 100 with a heated plate 7. Optionally, the heat may also be provided through steam, hot liquid, radiation, or hot air in the stain removing process. With regard to the drying process, the heat may be provided through a heated plate 7, radiation, or hot air.

3. In this device 1, the rinsing process is conducted through the addition of water 200 to dilute the chemical 300, followed by a brush 8 which removes excess water. Heated water 200 has better rinsing results. Optionally, the dilution may be achieved by using a chemical neutralizer or other medium. The process of post-dilution water extraction is optional, but it greatly enhances the rinsing effect. The post-dilution water extraction may also be achieved through other mechanical means, such as a tapping motion, rubbing motion, high velocity steam and so on.

4. In this device 1, drying is achieved through heating of the post-rinse area with the heated plate 7 at elevated temperature, in the range of 100-170° C. Optionally, hot air of over 60° C. may also be used for drying.

In conclusion, this invention is a device 1 for stain removal. The device 1 can have the function of stain removal and/or rinsing. It may also have the function of drying. This device 1 uses heat to accelerate the stain removal process, then uses the means of chemical dilution and residue extraction to remove the chemical residues, so that the fabric 100 can continue to be in service prior to the next laundry cycle. The device 1 also uses heat to further drying the fabric 100 after the rinsing process. The integration of these functions enables the user to use the fabric 100 immediately after the proposed three steps of the stain removal process.

In the present invention, the device 1 can further comprise a guide head 14. The guide head 14 comprises a back end interface 15 and a front end interface 16. The back end interface 15 receives the steam 200 produced from the main body of the device 1, the front end interface 16 gathers the steam 200 into a spout 17 facing the stains on the fabrics. The guide head 14 may comprise an insert slot 18 on the side of the guide head 14 near the back end interface 15. The insert slot 18 is equipped with an insert piece 600 inserted therein. The stain removal insert piece 600 contains stain removing material 300 inside and is applied to produce the chemical reagent 300 in the help of the steam 200 produced by the main body of the device 1 during the stain removing process. The stain removal insert piece 600 may also be called a holder 600 configured to contain a stain removal container 400.

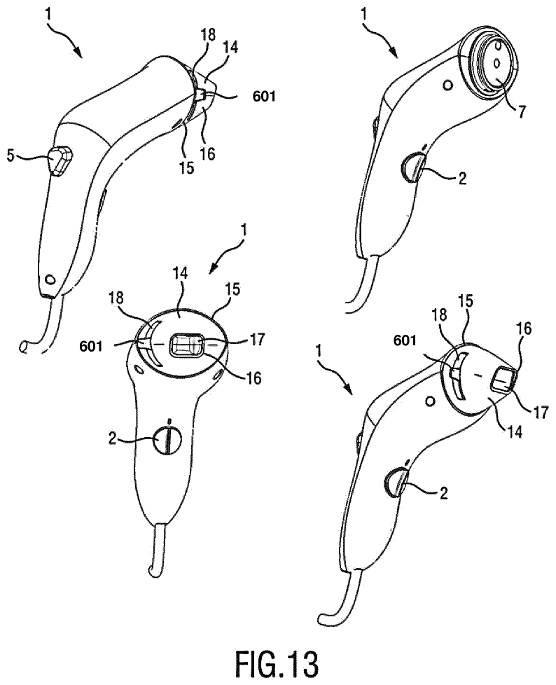

FIG. 13 shows various schematic perspective views of a portable device 1 using a guide head 14 for removing the stains on a fabric 100 according to an embodiment of the present invention.

The stain removing material 300 can be bleach contents. Most of bleach contents 300 (Sodium percarbonate, TAED, DOBA, NOBS, etc) used in a laundry cleaning or dish washer products are in solid form (e.g. powder, granule). The bleach solid 300 requires to be dissolved in water in order to release H₂O₂ or peroxy acid. H₂O₂ or peroxy acid kills bacteria and removes stains on a substance like fabric, glass, or plastic by oxidizing the stain molecules from colored structure to colorless structure.

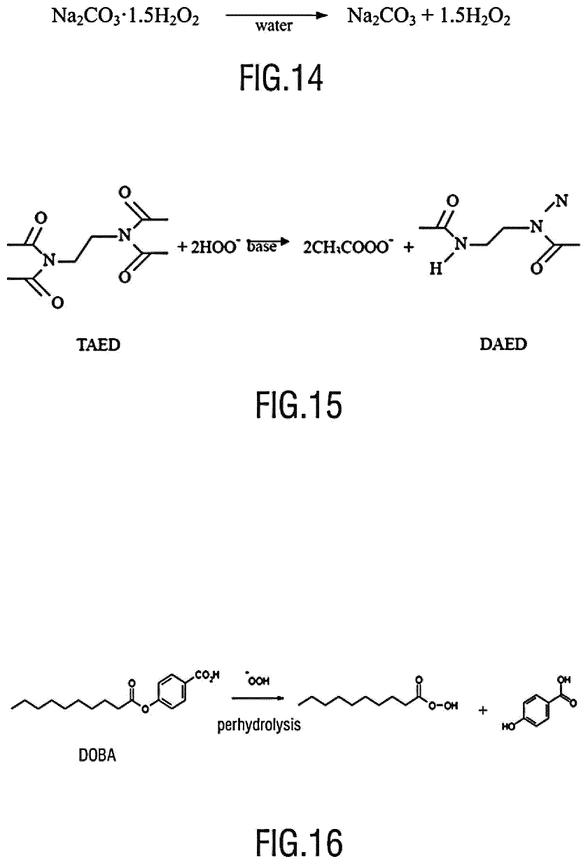

FIG. 14, FIG. 15 and FIG. 16 are respectively chemical formations of H₂O₂ from sodium percarbonate, peracetic acid from TAED, and perhydrolysis reaction of DOBA.

The water dissolving rate of the bleach solid increases while the temperature increases. So H₂O₂ or Peroxy acid will be released very fast while in contact with steam 200 or hot water 200.

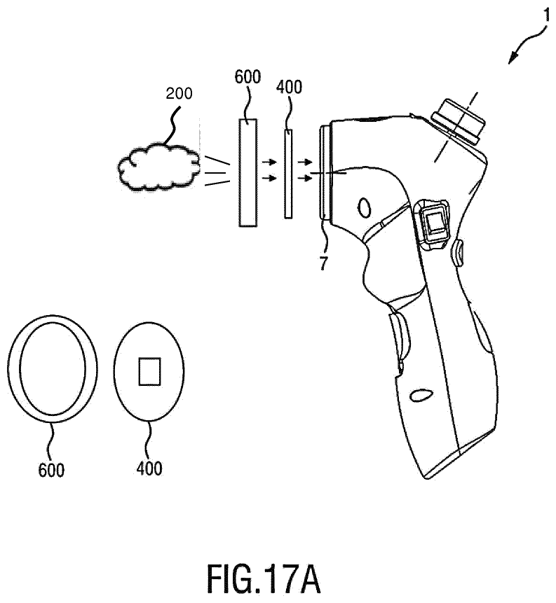

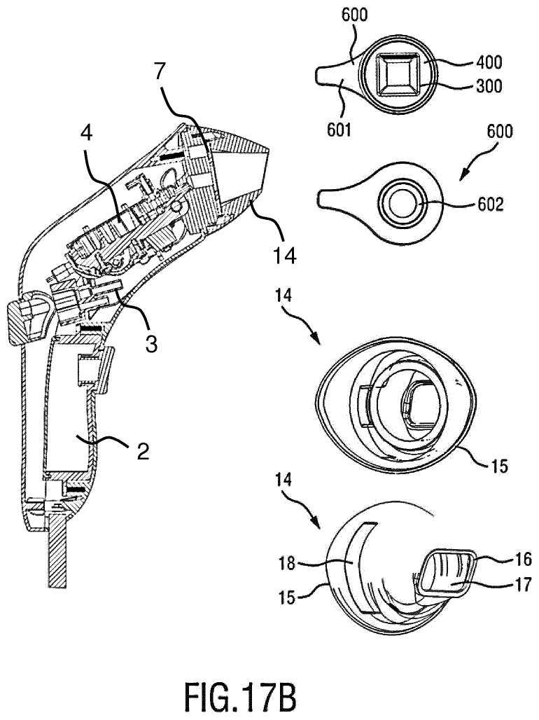

The embodiment of FIG. 17A discloses a stain removal container 400 which may be configured as a bag, a pad, a cartridge, a sachet or a disposable capsule containing bleach powder 300 to be directly attached to a stain removal device 1, which can produce heat, steam 200 and/or hot/cold water 200 and release bleach solution 300 instantly while steam 200 or water 200 passing through the bag 400. The bag material should be water permeable and can be made of high density paper, fabric, non-woven fabric, porous plastic, etc.

The shape of the capsule bag 400 can be different. For example, circular, elliptic, triangular, rectangular, square, semi-circular or semi-elliptic. Dependent on the stain size and concentration the bag size and powder amount are variable as well.

As for the existing technical solutions compared with the present invention, based on the applicant's study and analysis, the existing solution has some disadvantages as follows:

1. A container is needed to dissolve the bleach chemical 300 in water 200 and the dissolving process is lengthy without mixing force like stirring.

2. It is inconvenient for a consumer to mix the bleach chemical every time before treating a stain.

3. It adds an additional module to a stain removal product.

Preferably, the container 400 takes any of the forms defined by a bag, a pad, a cartridge, a sachet, and a capsule. The bag may look like a “tea bag” with fluid-permeable external layer.

It may include an optional frame 600, also called a holder in the following, which can be mounted onto the steam venting face (sometimes combined with the heated plate together) of the device 1, the frame 600 can also be mounted onto a steamer head.

It also includes bleach solid/powder 300 embedded in a bag/satchel 400 with or without a support holder 600.

It may also include an optional support holder 14 (in somewhere of the invention it's called guide head) which is able to be inserted and fixed into the frame 600.

The first working mechanism of it can be to mount this accessory (support holder 14 or guide head 14) to a steam generation device, a steamer, for example. The steam 200 passes through the “tea bag” 400 or capsule 400 while use. The bleach solids 300 inside the bag 400 or capsule 400 will dissolve by the condensation and carried out by steam 200.

FIG. 17A is a schematic side view of the stain removal device 1 as well as the chemical reagent bag 400 and the holder 600 of a portable device 1 using the holder 600 for removing the stains on a fabric 100 according to an embodiment of the present invention. In a second mechanism, the bleach solid containing capsule/bag 400 is used with a hot water/steam generating stain remover device 1. The device 1 contains a small water tank 2 and releases hot water/steam 200 while treating the stain. The hot water/steam 200 passing through the bag 400 carries out the bleach solution 300. The bag 400 can be used as a separate part or the shape of the bag can be designed accordingly to fit onto the front frame of the device 1.

Then let's adopt the guide head 14 hereinafter as an embodiment to further describe the embodiments of the present invention. As having already depicted above, the device's guide head 14 may comprise a back end interface 15 and a front end interface 16, the back end interface 15 receives the steam 200 produced from the main body of the device 1, the front end interface 16 gathers the steam 200 into a spout 17 facing the stains on a fabric 100.

FIG. 17B are internal schematic side views of the stain removal device 1 as well as the chemical reagent bag 400 and the guide head 14 of a portable device 1 using a guide head 14 for removing the stains on a fabric 100 according to an embodiment of the present invention. In particular, it is shown that the holder 600 of the stain removal container may comprise a holding tab (also called a hand grip) 601 configured to make inserting the holder 600 into the stain removal device 1 easier. Furthermore, the holder 600 of the stain removal container 400 may comprise a rear 602 to reduce contact with the heated plate 7 when the holder 600 is attached to the device 1.

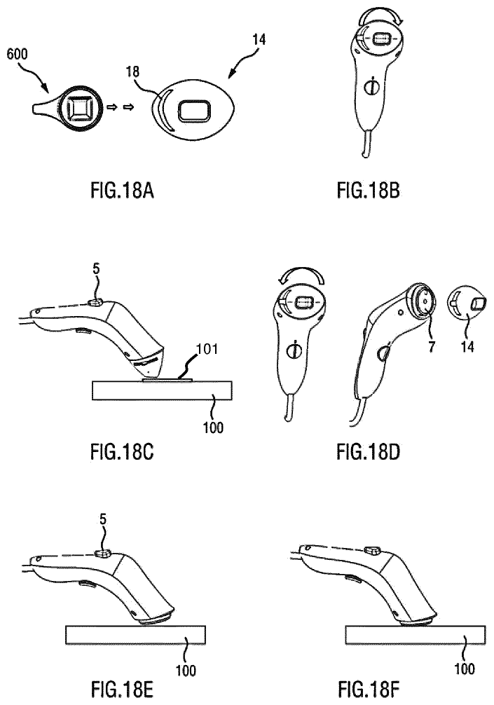

FIG. 18A to FIG. 18F is a set of schematic usage flow charts of the portable device 1 with a guide 14 head and a chemical reagent bag 400 for removing the stains on a fabric 100 according to an embodiment of the present invention. The guide head 14 in the present embodiment can also be replaced by a holder 600 to be attached to the steam venting face of the device 1 for holding a chemical bag 400.

In a word, as most of bleach contents 300 (Sodium percarbonate, TAED, DOBA, NOBS, etc.) used in a laundry cleaning or dish washer product is in solid form (e.g. powder, granule), the bleach solid requires to be dissolved in water 200 in order to release H₂O₂ or peroxy acid. Thus this embodiment discloses a disposable accessory 400 containing bleach powder 300 to be directly attached to a stain removal device 1 and to release bleach solution 300 instantly while usage accordingly.

As mentioned above, the usage of an integrated stain removal device 1 can be classified under three main processes.

After inserting the stain removal container 400 in the guide head 14 as shown in FIG. 18A and locking the guide head attachment 14 to the device 1 as shown in FIG. 18B, the tree main processes of stain treatment can be carried out.

FIG. 18C shows the stain removing process.

Cleaning reagents 300 are pre-filled in a cartridge, capsule, or a sachet 400 and are dispensed onto the stained area of the fabric, thanks to steam/water passing through the container/sachet 400. The device 1 also provides heat to the stain area 101 to accelerate the reacting, dissolving or covering rate. Heat sources include but are not limited to steam, conduction, IR heat and microwaves. In order to activate the treatment process, the rinsing pump trigger 5 has to be pressed (possibly repeatedly).

One of the usage situations shows examples of using a disposable cleaning powder sachet 400 or liquid film as cleaning agent 300, water and steam 200 carried by the device 1 pass through the sachet 400 to dissolve the powder 300 and carry the liquid/steam 200 onto the stain area 101.

FIG. 18E shows the rinsing process.

The main objectives of this stain rinsing process are:

1) to stop the chemical reaction upon the complete removal of the stain, so as to prevent further chemical reactions.

2) to remove chemical reagents 300 and their by-products from the garment to avoid possible irritation/allergic reactions when the garment is put on.

The rinse process can be achieved by either neutralization of the chemical or dilution of the chemical. For the best rinsing result, these chemical residues should be extracted from the fabric by an absorption means or by mechanical forces. The rinsing process is activated by pressing the rinsing pump trigger 5 (possibly repeatedly).

FIG. 18D shows the detachment of the stain removal container 400 from the device 1.

To guarantee that the liquid 200, i.e. the water, steam, neutralizer or a combination of all, is not contaminated by the remaining chemicals in front, the sachet or cartridge 400 needs to be removed beforehand. This creates one more action step for the user to un-tighten and take off the sachet or cartridge 400 and find a place to put aside.

FIG. 18F shows the drying process.

Drying of the post-rinse fabric 100 relies on removal of the moisture on the fabric 100. The moisture can be evaporated through direct heating with a hot plate 7 (˜100-170° C.) or heated air 7 (˜60-100° C.).

So the present embodiment may have these technical benefits (in stain removing process and rinsing process) as follows which will be demonstrated hereinafter:
1. Save the step of removing the chemical 300 contained in the capsule/sachet/cartridge.
2. Save the space of placing the removed chemical containing part 400.

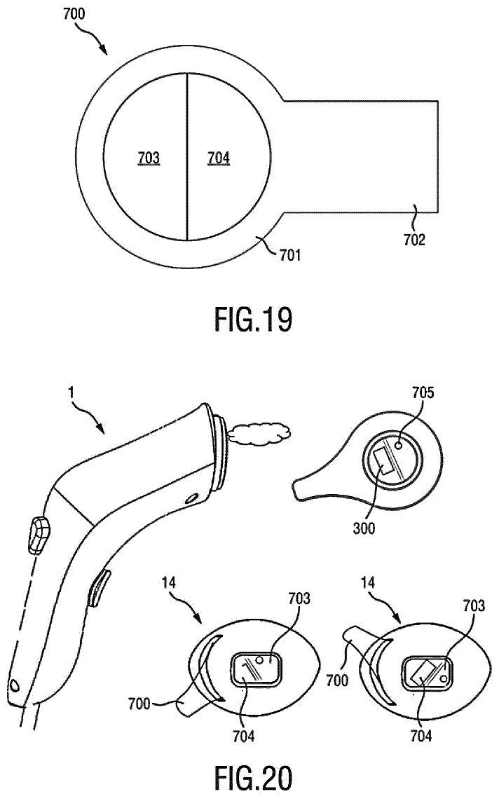

FIG. 19 is a schematic front view of a pathway selector 700 of the device 1 according to an embodiment of the present invention. The main features of the invention may include (but not necessarily all of them are essential):

1. A frame 701 with a hand grip 702 for rotating the pathway selector and preventing finger burn while rotating.

2. The frame 701 can be attached to the front head (having the steam venting face) of the stain remover device 1.

3. The front head of the stain remover device 1 has markings of “treatment” and “rinsing” to indicate the position of the frame 701.

4. A cleaning reagent sachet/cartridge 400 can be inserted into the first part 703 of the frame 701, while the second part 704 of the frame 701 can be left empty or contains neutralizer or fragrance (or vice versa).

5. Fluid like water 200 passes through the cleaning reagent containing side during treatment process.

6. Fluid like water 200 passes through the clean side during rinsing process.

So this structure allows a selectable water pathway for stain treatment and rinsing in a stain removal device.

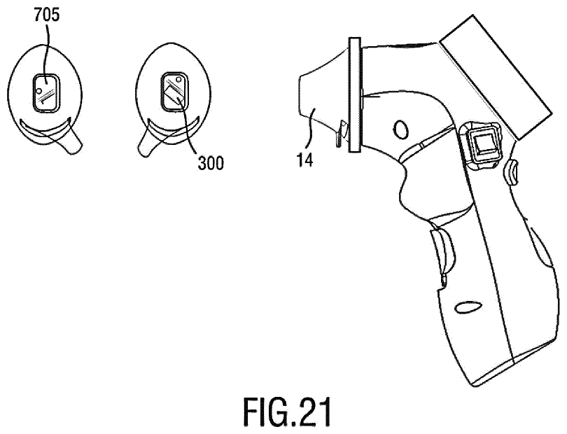

FIG. 20 and FIG. 21 show two application situations for the pathway selector 700, also called selectable pathway piece in the following, of the device 1 according to an embodiment of the present invention. It can be understood that the working face of the insert slot 18 (i.e. selectable pathway piece 700) can be divided into at least two parts: the first part is for storing up the stain removing materials 300, the second part is empty and may comprise a hole 705 for rinsing. The insert slot 18 is turnable, providing the first part 703 or the second part 704 facing the steam 200 produced from the main body of the device 1. Thus, the device 1 can provide two different functions by turning up or turning down, or turning left or turning right the hand grip 702 of the pathway selector in which one half is loaded with the bleach solid and the other half is empty. That is to say, the working face of the insert piece 600, i.e. in this embodiment a pathway selector 700, is divided into at least two parts, the first part is for storing up the stain removing materials, the second part is empty. The pathway selector 700 is turnable inside the insert slot 18, providing the first part 703 or the second part 704 facing the steam 200 produced from the main body of the device 1.

Instead of rotation motion, other executions to switch the fluid pathway selector 700 can be flipping and un-flipping the frame 701 as well.

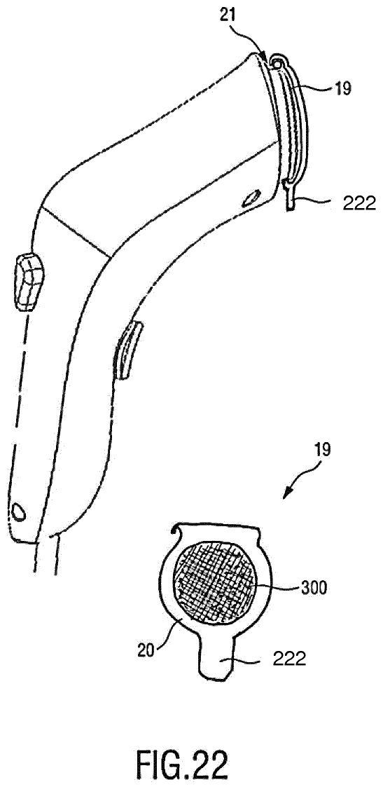

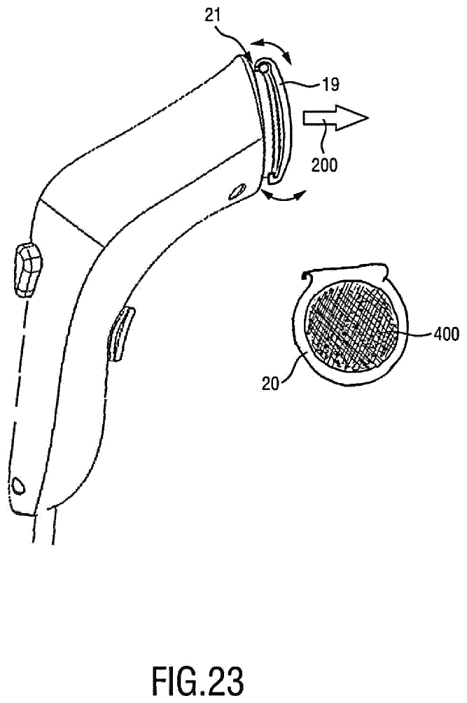

FIG. 22, FIG. 23 and FIG. 24 are other three application situations for the selectable pathway piece 700 of the device 1 according to an embodiment of the present invention.

It can be understood that the device 1 may further comprise a flap-flip piece 19 instead of a guide head 14 with an insert piece 600 The flap-flip piece 19 comprises a frame 20 which is attached to the steam-venting face of the device 1 by a hinge 21. The flap-flip piece 19 may contain stain removing materials 300 inside, e.g. in form of a stain removal chemical bag 400, and is applied to produce the chemical reagent 300 with the help of the steam 200 produced by the main body of the device 1 during the stain removing process. The frame 20 may also comprise a hand grip 222 in order to prevent finger burn. Besides, the flap-flip piece 19 can be locked to the device to ensure that the stain removing materials get maximum contact to the steam or liquid 200 coming from the device 1.

FIG. 23 depicts the situation when the flap-flip piece 19 is locked to the device 1.

FIG. 24 depicts an embodiment of the present invention, wherein the flap-flip piece 19 is unlocked and folded by means of the hinge 21 such that the stain removing materials 300 inside the frame 20 no longer face the steam or liquid 200 coming from the device.

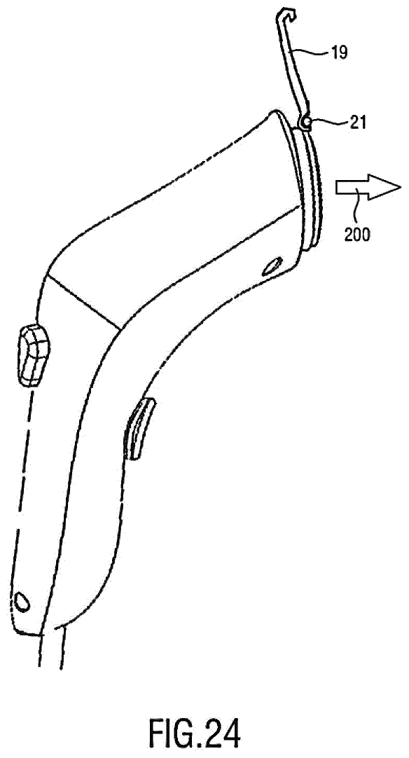

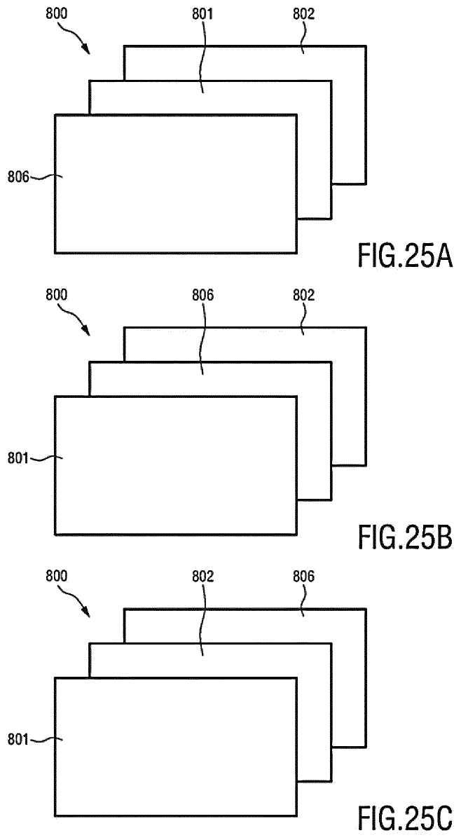

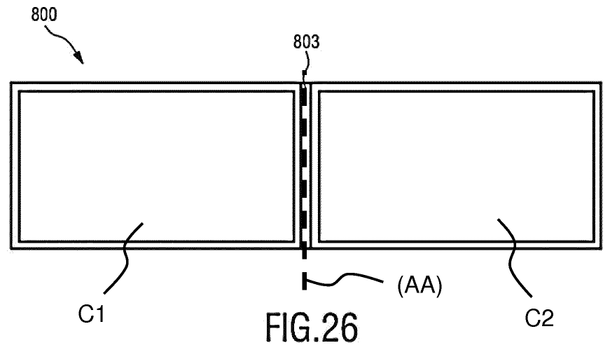

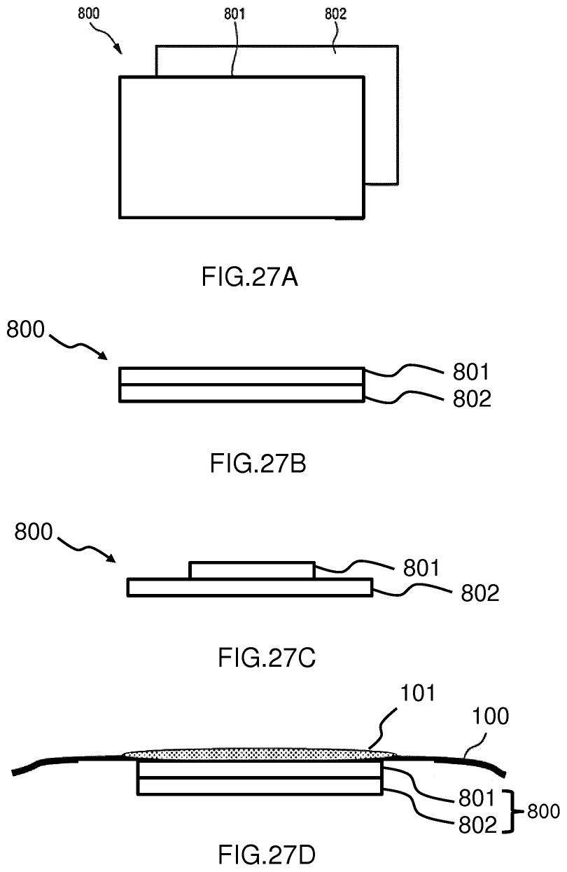

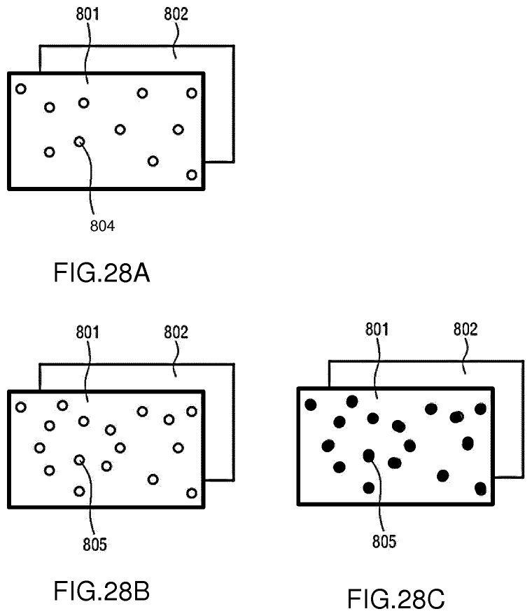

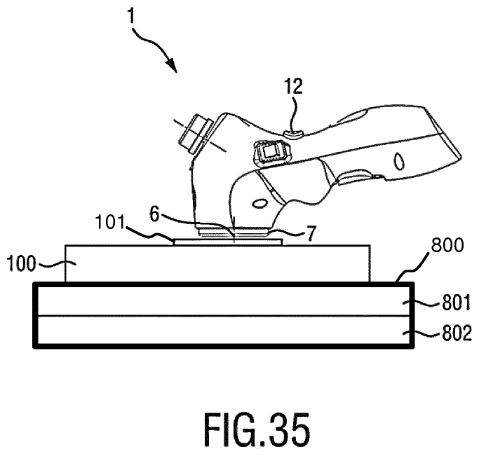

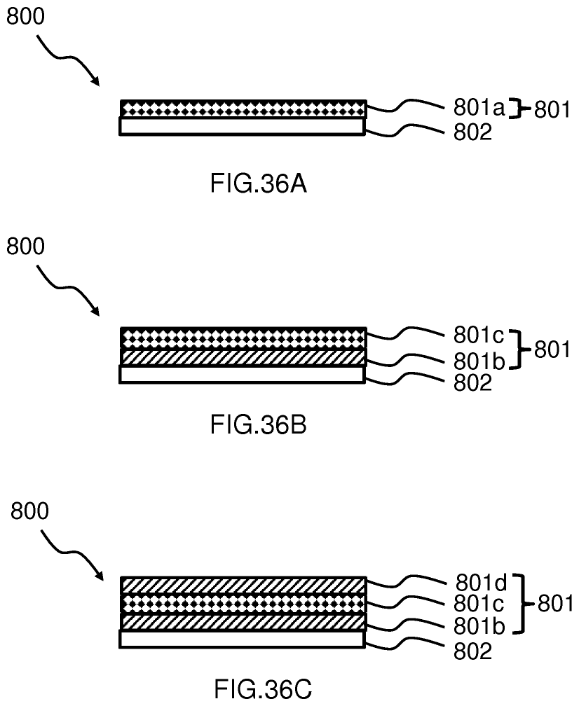

In the present invention, the device may further comprise an absorbent backing pad 800 intended to be placed underneath the fabric 100, as illustrated in FIG. 27D or FIG. 35, under the stain area 101, during the stages of stain removing, rinsing and/or drying, in order to absorb the wet from the fabric 100, for example in order to dry the fabric 100. Detailed information on the backing pad will be provided hereinafter along and illustrated via FIG. 27A to FIG. 27D, FIG. 25A to FIG. 25C, FIG. 26, FIG. 28, FIG. 35 and FIG. 36.

FIG. 27A to FIG. 27D is a set of schematic views of a backing pad according to the present invention.

The backing pad 800 according to the invention is intended to be used in a stain removal process. The backing pad 800 comprises:
an upper layer 801 being fluid-absorptive,
a lower layer 802 being fluid-impermeable,
   The upper layer 801 and the lower layer 802 are stacked on each other.
   The upper layer 801 comprises a superabsorbent.
   The superabsorbent polymerizes to gel and retain the fluid getting into contact with the superabsorbent.
   By superabsorbent, it is referred to:
polymeric material being capable of absorbing large quantities of fluid by swelling and forming a hydrated gel (hydrogel)
material generally falling into three classes, namely, starch graft copolymers, cross-linked carboxymethylcellulo se derivatives and modified hydrophilic polyacrylates.
   Some examples of such absorbent polymers are hydrolyzed starch-acrylonitrile graft copolymer, a neutralized starch-acrylic acid graft copolymer, a saponified acrylic acid ester-vinyl acetate copolymer, a hydrolyzed acrylonitrile copolymer or acrylamide copolymer, a modified cross-linked polyvinyl alcohol, a neutralized self-cross-linking polyacrylic acid, a cross-linked polyacrylate salt, carboxylated cellulose, and a neutralized cross-linked isobutylene-maleic anhydride copolymer.

FIG. 27A depicts an exploded view of the upper layer (801 and the lower layer 802 before assembly.

FIG. 27B depicts a cross-section view of the upper layer 801 and the lower layer 802 stacked on each other.

FIG. 27C depicts a cross-section view of the upper layer 801 and the lower layer 802 stacked on each other, where the areas of the upper layer 801 and the lower layer 802 are different. Preferably, as illustrated, the area of the lower layer 802 is larger than the area of the upper layer 801.

For example, the side length of the upper layer (801) and the lower layer (802) is larger than 5 cm if the target size of the stained area size is less than 5 cm. More preferably the side length is larger than 10 cm if the stain treatment area is separated from the rinsing and drying area.

For example, the upper layer and the lower layer are attached together by using adhesive material, such as glue.

In general, the backing pad can be applicable to all the stages (stain removing, rinsing and drying) that involve fluid absorption and retaining, in order to prevent fluid overflow and fluid contamination with other objects.

This backing pad 800 is especially suitable to be used together with a hand-held stain removal device 1 which is able to locally treat stain spots on fabric 100, e.g. garment, without the need of washing the whole garment 100. This usage is illustrated in FIG. 35. The hand-held stain removal device 1 has integrated functions of:

1) stain treatment by water/steam 200 or by cleaning chemical 300, or by water/steam 200 plus cleaning chemical 300;

2) rinsing off stain residue and chemical residue;

3) evaporate water 200 on the treated area of the garment 100.

At stage 1, the process involves various chemicals 300 and chemical solutions 300 (around 3˜5 ml of chemical cleaning solution 300 to be used to remove a stain of 5 cm diameter), and the absorption backing pad 800 will be put underneath the stain area 101 of the garment 100 to prevent chemical contamination of operation tables and desks, or even users' skin if the backing pad is hold manually by user during treatment. In order to avoid the solution to expand, the upper layer 801 should be very absorptive and permeable.

Preferably, the superabsorbent comprises a hydrophilic polymer.

For example, the superabsorbent is chosen from a copolymer or a polymer including at least one of a acrylonitrile based copolymer, an acrylamide based copolymer and a polyvinyl alcohol (PVA) based copolymer, poly acrylic acid, poly(vinyl alcohol), poly ethylene oxide (PEO).

FIG. 36A to FIG. 36C illustrate different embodiments of a backing pad according to the present invention implementing different fluid-absorptive upper layers.

The upper layer 801 comprises any one of the following structure:
a) a single layer 801a comprising a mixture of fluid-permeable fibrous material and superabsorbent polymer being stacked on the lower layer 802. This embodiment is illustrated in FIG. 36A.
b) a first layer 801b comprising fluid-permeable fibrous material arranged adjacent to a second layer 801c comprising a mixture of fluid-permeable fibrous material and superabsorbent polymer. For example, the first layer 801b is stacked on the lower layer 802, and a second layer 801c is stacked on the first layer 801b. This embodiment is illustrated in FIG. 36B. As an alternative, the stacking order of the first layer and second layer could be reversed (not shown).
c) a first layer 801b comprising fluid-permeable fibrous material being stacked on the lower layer 802, a second layer 801c comprising a mixture of fluid-permeable fibrous material and superabsorbent polymer being stacked on the first layer 801b, and a third layer 801d comprising fluid-permeable fibrous material being stacked on the second layer 801c. This embodiment is illustrated in FIG. 36C.

Similarly, a higher number of layers made of fluid-permeable fibrous material and superabsorbent polymer could be further stack on each other successively.

In those various structures, the fluid-permeable fibrous material allows to maintain particles of the superabsorbent polymer which often are under an initial powder or granular form, in an alternate order.

For example, the fluid-permeable fibrous material corresponds to wood pulp or cotton linters.

It is noted that the fluid-permeable fibrous material can stay as “one block” together with the superabsorbent polymer by using pressure and/or vacuum during assembly of those two materials.

The bottom layer, i.e. lower layer, 802 of the absorption pad is non-permeable to water and chemical solutions. Preferably, lower layer 802 is made of a material comprising any one of plastic sheets, metal sheets, rubber sheets, wax paper, leather sheets and glass sheets.

At stage 2, water 200 will be dosed on the stain treatment area to rinse off the stain residues and cleaning agents/chemicals. 10-100 ml water 200 should be used depending on the residue amount, which means that the absorption capacity per area of the upper layer 801 unit needs to be adapted accordingly to avoid flooding (i.e. fluid is no more absorbed by the upper layer).

At stage 3, rinsing water 200 left on the garment from stage 2 will be evaporated by heating to 100-200° C. depending on the stain, chemical 300 used and garment type (i.e. fabric) under treatment.

Preferably, taking the high temperature of the drying stage into consideration, the upper layer 801 is made of a heat resistant material to avoid be damaged by the heat provided by the external device, and/or the lower layer 802 is made of a heat resistant material to avoid the support on which the garment and pad are placed be damaged. Cotton and cellulose are preferred materials.

The absorption pad 800, also named backing pad, is meant to be put underneath the stain area 101 of the garment 100 to achieve better results for each stage.

The advantages of the embodiment can be concluded as follows:
1. Convenient to use on many kinds of fluid absorption and retaining;
2. Providing protection to operation desk, preventing contamination and heat damage;
3. Enhancing efficiency of the stain removal process in terms of rinsing and drying.

FIG. 25A to FIG. 25C are schematic exploded views of backing pads 800 according to the present invention comprising an additional layer 806.

The additional layer 806 cooperates with any one of the upper layer 801 and the lower layer 802 for providing mechanical stability and/or protection to the backing pad 800. For example, the additional layer 806 may be a permeable layer or an impermeable layer and may be added as e.g. a heat seal on top to provide physical strength and protection to any one of the upper layer 801 and the lower layer 802.

FIG. 25A shows a backing pad 800 with the additional layer 806 arranged on top of the upper layer 801, and the lower layer 802 below the first 801. In this embodiment, the additional layer 806 is fluid permeable. In this arrangement, the additional layer 806 enhances the structural integrity and strength of the backing pad.

FIG. 25B shows a backing pad 800, wherein the additional layer 806 is arranged in between the upper layer 801 and the lower layer 802. In this embodiment, the additional layer 806 is fluid permeable or fluid impermeable.

FIG. 25C shows a backing pad 800, wherein the additional layer 806 is arranged below the lower layer 802, and the upper layer 802 is arranged above the lower layer 802. In this embodiment, the additional layer 806 is fluid permeable or fluid impermeable.

FIG. 26 is a schematic front view of a backing pad according to the present invention comprising at least two compartments.

In order to prevent cross contamination, the backing pad 800 can be divided into at least two isolated areas by putting a non-permeable barrier 803 in-between each compartment.

In the example of FIG. 26, the backing pad 800 is isolated into two compartments C1 and C2. A water proof barrier 803 is slotted in the middle. Preferably, the backing pad 800 is foldable by having the two compartments being foldable around axis (AA).

The compartments may be used for different treatment stages:
One compartment may be used during stain treatment, whereas the other compartment of the backing pad may be used when rinsing the treated garment, for example.
One compartment may be used for all stages of a given stain treatment process, and the other compartment of the backing pad will be used successively for treating other stains in the future.

Similarly, the backing pad may also be divided in more than two compartments (not shown). For convenient use on local small stains, each side of the pad 800 is estimated to be around 10*10 cm. The two (or more) compartments can be folded back to back in order to save space.

FIG. 28A to 28C is a schematic front view of a backing pad according to the present invention embedded with one or more additives.

One or more additives may be embedded into the backing pad 800, in particular into the upper layer in order to deliver better various results and user perception:

1) the upper layer 801 comprises fragrance and/or perfume agents 804, illustrated in FIG. 28A. Fragrance or perfume additives help to create better user perception. Different scents can be used on different areas of the pad. For example, compartment C1 of the backing pad for stage 1 and 2 releases a first scent which reminds the user of hygiene and cleaning; compartment C2 of the baking pad for stage 3 releases a second scent which gives user impression of freshening.

2) the upper layer 801 may comprise a pH indicator agent 805 adapted to indicate acidity or alkalinity of fluid getting in contact with the upper layer 801, illustrated in FIGS. 28B and 28C. The pH indicator 805 is a chemical which exhibit color change over pH value change. If the chemical cleaning agent used is acidic or alkaline, when it touches the backing pad, the color of the pad will change gradually as an indication of the presence of the cleaning agent. The change of color first indicates the start of the stain treatment (stage 1) and gives the user the feedback that the stain removing is under action. During rinsing (stage 3), the pH indicator gives a visual feedback to the user that the rinsing is finalized (the remaining bleach chemical has been neutralized and has reached a neutral value).

Most solid form chemical cleaning agents 300 and some liquid detergents 300 show alkaline nature when dissolved in water 200. So alkaline pH indicator 805 which are colorless (invisible) when pH is neutral and colorful when pH is larger than 8-10 (alkaline) are selected in the following below table 1. Table 1 is a schematic table of different chemicals indicators:

TABLE 1

| | Color | pH value | pH value | Color |
|---|---|---|---|---|
| Cresolphthalein | colorless | 8.2 | 9.8 | purple |
| Phenolphthalein | colorless | 8.3 | 10.0 | purple-pink |
| Thymolphthalein | colorless | 9.3 | 10.5 | blue |

FIG. 28B shows the backing pad 800 prior to stain treatment, while FIG. 28C shows the pad during and/or after stain treatment process. This illustrates that the pH indicator 805 has changed its color to reflect a change of the pH value.

In case the backing pad would comprise a plurality of compartments, such as illustrated in FIG. 26, for example a first compartment intended to be used during stain treatment, and a second compartment intended to be used during stain rinsing, the pH indicator is preferably put into the upper layer of the second compartment only.

3) the upper layer (801) comprises a chemical neutralizer 807 (not shown). To enhance the chemical residue rinsing capability of stage 2, neutralizers can also be pre-embedded into the backing pad. For most of cleaning agents 300 are alkaline based, weak acid like citric acid and sodium citrate can be good choices to neutralize pH. Preferably, the chemical neutralizer is selected among any one of the following:
weak acid-like citric acid and/or sodium citrate;
weak alkaline-like sodium carbonate and/or sodium bicarbonate;
reducing agents.

In case the backing pad would comprise a plurality of compartments, such as illustrated in FIG. 26, for example a first compartment intended to be used during stain treatment, and a second compartment intended to be used during stain rinsing, the chemical neutralizer is preferably put into the upper layer of the second compartment only.

This embodiment to be described is about the way of treating a stain using a chemical medium 300 in combination with user's heating devices that could be commonly found at households such as a garment steamer or a garment iron. The combination of chemical 300 and heat can give good stain removing speed and result. With this way of stain removing, the stain spot can be removed effectively without the need for washing the whole piece of fabric 100.

The stain removal chemical bag 400 which can be used in the present embodiment contains:
active oxygen sources, e.g. hydrogen peroxides (H₂O₂); Sodium percarbonate (Na₂CO₃.1.5H₂O₂); sodium perborate (NaBO₃.H₂O, or NaBO₃.4H₂O), etc.
Preferably also any one of the following bleach activator (taken alone or in combination):
   tetraacetylethylenediamine (TAED),
   4-decanoyloxybenzoic acid (DOBA),
   sodium salt of nonanoyloxybenzenesulphonic acid (NOBS),
   sodium salt of 3,5,5-trimethylhexanoyloxyphenylsulfonic acid (iso-NOBS),
   sodium salt of acetoxyphenylsulfonate,
   sodium decanoyloxybenzene sulfonic acid (DOBS), sodium
   octanoyloxybenzene sulfonic acid (OOBS),
   GOBS,
   sodium nonanoyloxybenzoic acid (NOBA),
   N,N-Diacetylethylenediamine,
   N-[4-(triethylammoniomethyl) benzoyl]butyrolactamchloride (TBBC),
   sodium trimethylhexanoyloxybenzenesulfonate (STHOBS),
   sodium-4-benzoyloxybenzenesulfonate (SBOBS),
   glucose pentaacetate (GPA),
   tetraacetylglucoluril (TAGU),
   nitrilotriacetate (NTA),
   transition metal bleach catalyst etc.

Please refer to FIG. 8 to FIG. 10 as some examples. There can be a chemical mixing tank 11, a water tank 2, a heated plate 7 and a rotary brush 8 with the integrated stain removal device 1. Thus, for the integrated stain remover 1, power supply 22 can be connected to household supply while in operation (with power cord) or to an energy accumulator (cordless). The energy accumulator can be a storage battery or a capacitor based storage. In this cordless case, the device 1 can be charged at home but used at other places like office or can be brought out for traveling.

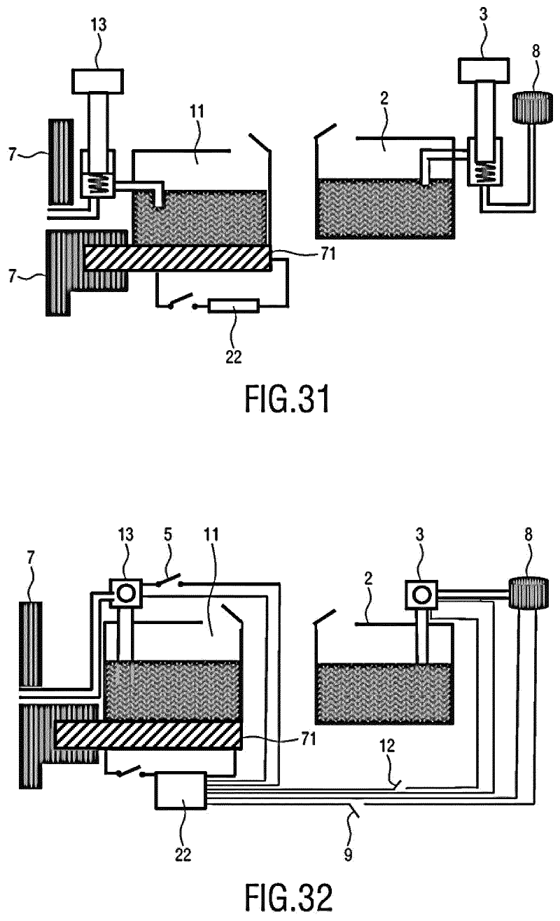

FIG. 31 is a configuration diagram showing the power supply 22 applied to heat up the heater 71, which supplies heat to the chemical mixing tank 11 and the heated plate 7, while the chemical dosing pump 13, rinsing pump 3 and brush 8 are mechanical according to an embodiment of the present invention.

FIG. 32 is a configuration diagram showing the power supply 22 applied to heat up the heater 71 to supply heat to the chemical mixing tank 11, and to provide electricity to the chemical dosing pump 13, also called chemical dispensing pump, and rotary brush 8 according to an embodiment of the present invention. Essentially, the power supply 22 can be used to heat up the chemical mixing tank 11 and the heated plate 7 (as shown in FIG. 31). Additionally, the power supply 22 may as well provide electricity to other components integrated like the pumps 3 and 13 and the brush 8 (FIG. 32). The pumps and the brush may be triggered by the rinsing pump trigger 5, the chemical dosing trigger 12 and the brush trigger 9, respectively.

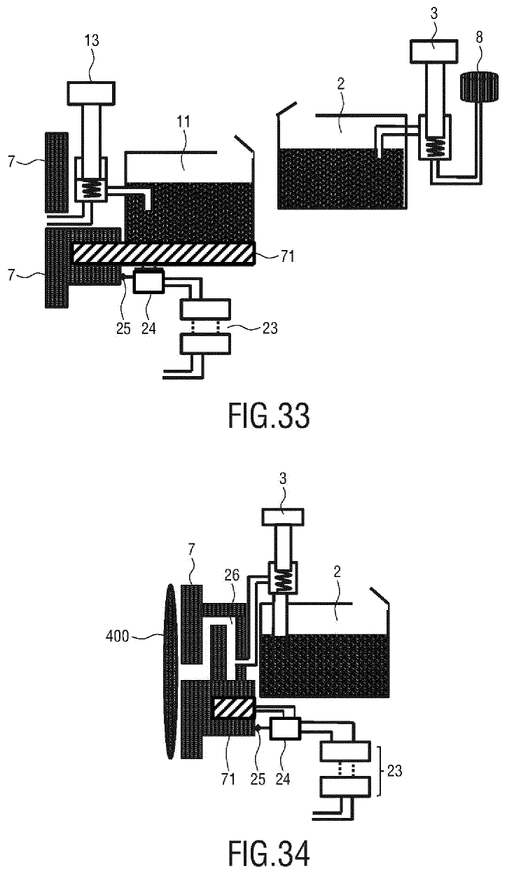

FIG. 33 is a configuration diagram showing detachable power supply 23 (similar to a cordless iron) applied to heat up the heater 71 to supply heat to the chemical mixing tank 11 and the heated plate 7, while pump 3, pump 13 and the brush 8 are mechanical according to an embodiment of the present invention. Another way to achieve cordless execution but not using electrical power storage is to adopt a detachable power supply 22 to only store thermal energy in a short period (similar to cordless irons as shown in FIG. 33). In this case, as there is no electricity energy accumulator or battery, pumps 3 and 13 and brush 8 remain mechanically driven (manual). The process of supplying electricity to the heater is controlled by a control unit 24. In particular, the control unit 24 receives information from the temperature sensor 25 to control the heater 71.

For the stain removal chemical bag (“tea bag”) to apply the bleach chemical 300, the bag 400 can be attached to a steam generating stain removal device 1 or a water dispensing stain removal device 1. For the water dispensing stain removal device 1, a way to achieve a cordless option is similar as specified above. For a steam generating stain removal device 1 comprising a steam chamber 26, a detachable power supply 23 is a more practical way, as steam requires large amount of thermal energy. FIG. 34 is a configuration diagram showing a steam generating stain removal device 1 with a detachable power supply 23 according to an embodiment of the present invention.

FIG. 35 shows a backing pad used in a stain removal process with a stain removal device 1. The stain removal device 1 is used to treat the stain area 101 on the fabric 100. Below the fabric 100 there is placed the backing pad 800 for absorbing the wet from the stain treatment. The fluid permeable upper layer 801 faces towards the fabric 100, whereas the impermeable lower layer 802 faces away from the pad 800. This way, the pad may absorb the wet effectively and at the same time prevent contamination of operation desks or other fabric parts.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the protective scope of the claims of the present invention. In the claims, the word “comprising” does not exclude other elements or steps, and the indefinite article “a” or “an” does not exclude a plurality. Any reference signs in the claims should not be construed as limiting the scope.

1. A backing pad for use in a stain removal process,
said backing pad comprising:
an upper layer, fluid-absorptive; and
a lower layer being fluid-impermeable,
said upper layer and said lower layer being stacked on each other, wherein the upper layer comprises a superabsorbent, and
wherein the backing pad comprises at least two compartments that are isolated from each other by an impermeable barrier.

2. The backing pad according to claim 1, wherein said superabsorbent comprises a hydrophilic polymer.

3. The backing pad according to claim 2, wherein the superabsorbent is chosen from a copolymer or a polymer including at least one of a acrylonitrile based copolymer, an acrylamide based copolymer and a polyvinyl alcohol (PVA) based copolymer, poly acrylic acid, poly(vinyl alcohol), poly ethylene oxide (PEO).

4. The backing pad according to claim 1, wherein the upper layer comprises any one of the following structure:
a) a single layer comprising a mixture of fluid-permeable fibrous material and superabsorbent polymer being stacked on the lower layer,
b) a first layer comprising the fluid-permeable fibrous material arranged adjacent to a second layer comprising the mixture of fluid-permeable fibrous material and the superabsorbent polymer, and
c) the first layer comprising the fluid-permeable fibrous material being stacked on the lower layer, the second layer comprising the mixture of fluid-permeable fibrous material and superabsorbent polymer being stacked on the first layer, and a third layer comprising the fluid-permeable fibrous material being stacked on the second layer.

5. The backing pad according to claim 1, wherein the lower layer is made of a material comprising any one of plastic sheets, metal sheets, rubber sheets, wax paper, leather sheets and glass sheets.

6. A backing pad for use in a stain removal process, said backing pad comprising:
an upper layer being fluid-absorptive; and
a lower layer being fluid-impermeable,
said upper layer and said lower layer being stacked on each other,
wherein the upper layer comprises a superabsorbent, and
wherein the upper layer comprises a pH indicator agent adapted to indicate acidity or alkalinity of a fluid getting in contact with the upper layer.

7. The backing pad according to claim 6, wherein the pH indicator is adapted to indicate acidity or alkalinity by color via a change of color when the fluid getting in contact with the upper layer is acidic or basic.

8. (canceled)

9. The backing pad according to claim 1, wherein the upper layer comprises fragrance and/or perfume agents.

10. The backing pad according to claim 1, wherein each of the at least two compartments comprises a different fragrance and/or perfume agent.

11. The backing pad according to claim 1, wherein the upper layer comprises a chemical neutralizer.

12. The backing pad according to claim 11, wherein the chemical neutralizer is selected among any one of the following:
weak acid-like citric acid and/or sodium citrate;
weak alkaline-like sodium carbonate and/or sodium bicarbonate; and
reducing agents.

13. The backing pad according to claim 1, wherein the backing pad is foldable.

14. The backing pad according to claim 1, further comprising an additional layer cooperating with any one of the upper layer and the lower layer for providing mechanical stability and/or protection to the backing pad.

15. A backing pad for use in a stain removal process, said backing pad comprising:
an upper layer being fluid-absorptive; and
a lower layer being fluid-impermeable,
said upper layer and said lower layer being stacked on each other,
wherein the upper layer comprises a superabsorbent, and
wherein the upper layer and/or the lower layer are made of a heat resistant material.

16. The backing pad according to claim 6, wherein said superabsorbent comprises a hydrophilic polymer.

17. The backing pad according to claim 6, wherein the upper layer comprises fragrance and/or perfume agents.

18. The backing pad according to claim 6, wherein the upper layer comprises a chemical neutralizer.

19. The backing pad according to claim 6, wherein the backing pad is foldable.

20. The backing pad according to claim 15, wherein said superabsorbent comprises a hydrophilic polymer.

21. The backing pad according to claim 15, wherein the backing pad is foldable.
